(19) United States
(12) Patent Application Publication
(10) Pub. No.: US 2015/0047671 A1
(43) Pub. Date: Feb. 19, 2015

(54) Floss and Toothbrush Holder

(71) Applicant: John R. Kordecki, Arlington Heights, IL (US)

(72) Inventor: John R. Kordecki, Arlington Heights, IL (US)

(21) Appl. No.: 14/459,855

(22) Filed: Aug. 14, 2014

Related U.S. Application Data
(60) Provisional application No. 61/959,101, filed on Aug. 15, 2013.

(51) Int. Cl. A47K 1/09; A61C 15/04

(52) U.S. Cl. CPC A47K 1/09; A61C 15/043
USPC 132/325; 29/428; 211/65

(57) ABSTRACT

A combination toothbrush and dental floss holder which allows at least one, and preferably two toothbrushes to be retained above a possibly contaminated surface. In alternate configurations, the toothbrush(es) may be retained in a vertical or horizontal orientation. The holder may even be positioned along the crimped end of a tube of toothpaste for greater distancing from the surface. An alternate embodiment uses a lid of a dental floss container to retain at least one toothbrush above a surface.

### RELATED APPLICATIONS

This application claims the filing priority of U.S. Provisional Application No. 61/959,101, titled “A DENTAL FLOSS CONTAINER W/A BUILT-IN TOOTHBRUSH HOLDER” and filed Aug. 15, 2013. The '101 application/patent is hereby incorporated by reference.

### TECHNICAL FIELD OF THE INVENTION

The present invention relates to holders for a toothbrush, and more specifically to a holder for at least one toothbrush and a package of dental floss.

### BACKGROUND OF THE INVENTION

The abundance of germs which reside on any given bathroom surface make it prudent to prevent the bristles of one's toothbrush from contacting the same. Accordingly, it is not uncommon from people to have a toothbrush holder in a personal bathroom. However, when traveling, the issue of where to set one's toothbrush in a hotel or the like is more than a little unnerving for some.

There does not appear to be a single preferred style of a toothbrush holder, as confirmed by the number of popular designs available. For example, there is the cup-type holder. From a sanitary prospective, this type of toothbrush holder, which relies on a base to support it, tends to collect moisture and other contaminants after a number of uses. The collection of such fluid and such allows mold and bacteria to flourish after only a short period of time. This is an undesirable condition for toothbrush storage.

Another type of holder is a permanently affixed wall-mounted holder with holes for allowing a toothbrush to hang from the brush head. These holders also tend to retain moisture and contaminants. More unfortunately, the build-up is around the area that holds the bristles as the toothbrush hangs vertically. This particular style also lacks in providing a sanitary environment.

With respect to traveling, many hotels do not provide a toothbrush holder, making the dilemma of where to lay one's toothbrush even more troubling. Until the invention of the present application, these and other problems in the prior art went either unnoticed or unsolved by those skilled in the art.

The disclosed invention addresses and solves the above problems, as well as others, by incorporating the three components believed to be necessary for proper oral hygiene: toothpaste, toothbrush and dental floss. The invention combines these components into one efficient storage arrangement.

### SUMMARY OF THE INVENTION

There is disclosed herein a dental care holder which avoids the disadvantages of prior devices while affording additional structural and operating advantages.

In a first embodiment, the holder comprises a body having a first flange extending at an angle from one end and a second flange extending at an angle from an opposite end. The two flanges extend in substantially opposite directions. The first flange includes at least one opening which is used to engage the handle of a toothbrush. The second flange may be used as a stand and/or to retain a container of dental floss.

As a possible additional feature, the first flange may have an initial section which extends at an acute angle relative to a surface of the body portion. The resulting narrowed area forms an engagement section which allows the holder to be retained on a crimped end of a tube, such as toothpaste.

In an alternate embodiment, the holder is formed from a dental floss container. At least one hole is made in a hinged lid of the container to allow a toothbrush handle to be inserted and retained therein. The entire floss container and toothbrush may be retained on the crimped end of a tube, e.g., toothpaste.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIGS. 1a-1b are perspective views of a first embodiment of the disclosed holder and three items for good dental hygiene;

FIG. 2 is a perspective view of the first embodiment being used to support a toothbrush above a surface;

FIG. 3 is another perspective view of a variation of the first embodiment having a single toothbrush opening and supporting a toothbrush in a second configuration;

FIG. 4 is a perspective view of a second embodiment of the disclosed holder having two toothbrush openings and being made from a dental floss container;

FIG. 5 is a perspective view of a variation of the second embodiment having a single toothbrush opening;

FIG. 6 is a perspective view of the embodiment of FIG. 4 including a retained toothbrush;

FIG. 7 is a side view showing the embodiment of FIG. 4 positioned to engage a crimped end of a tube;

FIG. 8 is a perspective view of the embodiment of FIG. 5 including two retained toothbrushes; and

FIG. 9 is a perspective view of the embodiment of FIG. 4 in an alternate configuration for retaining two toothbrushes.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

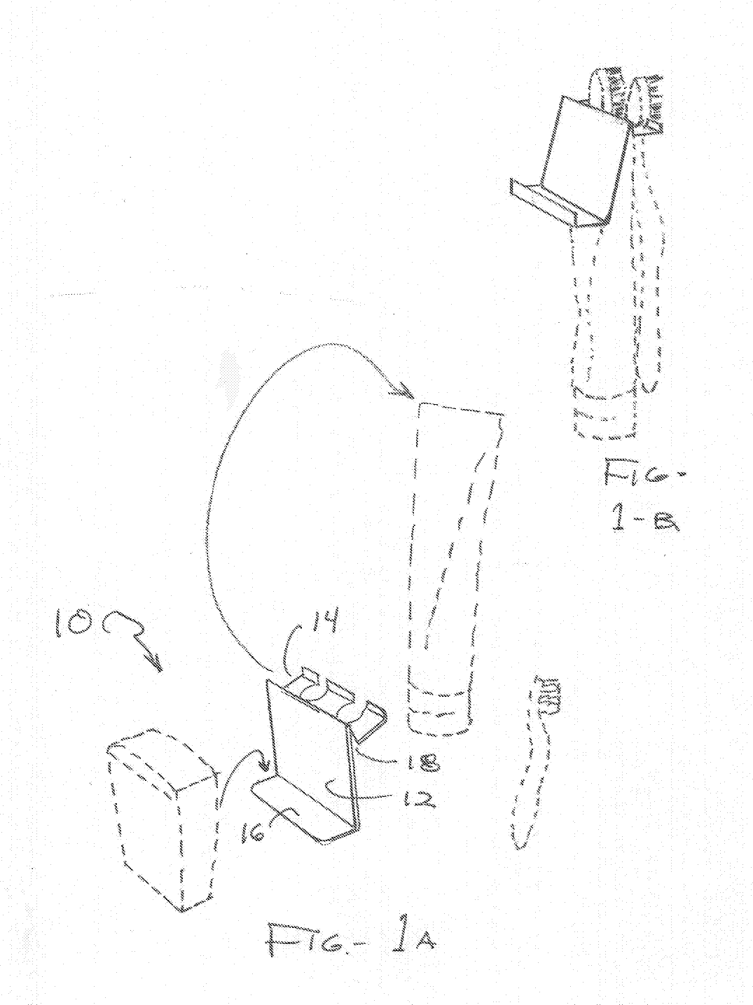

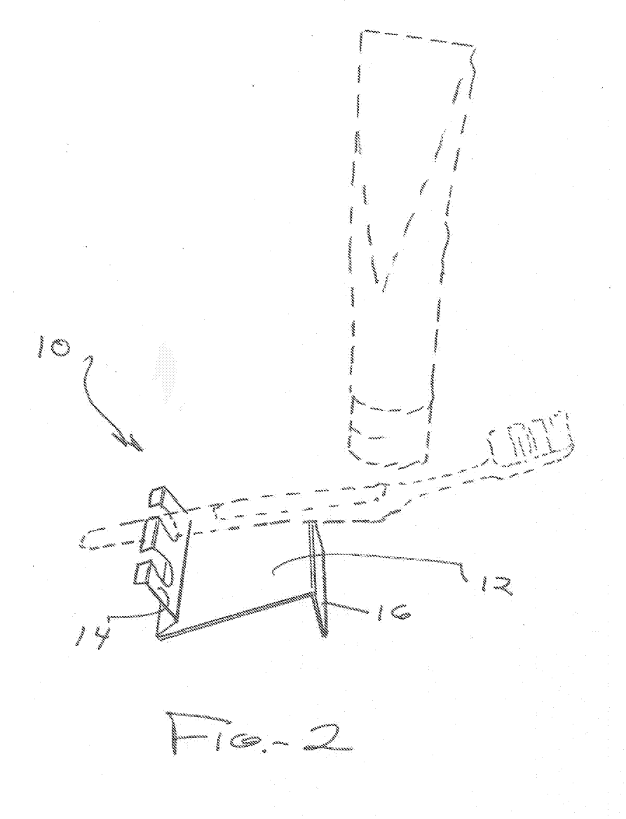

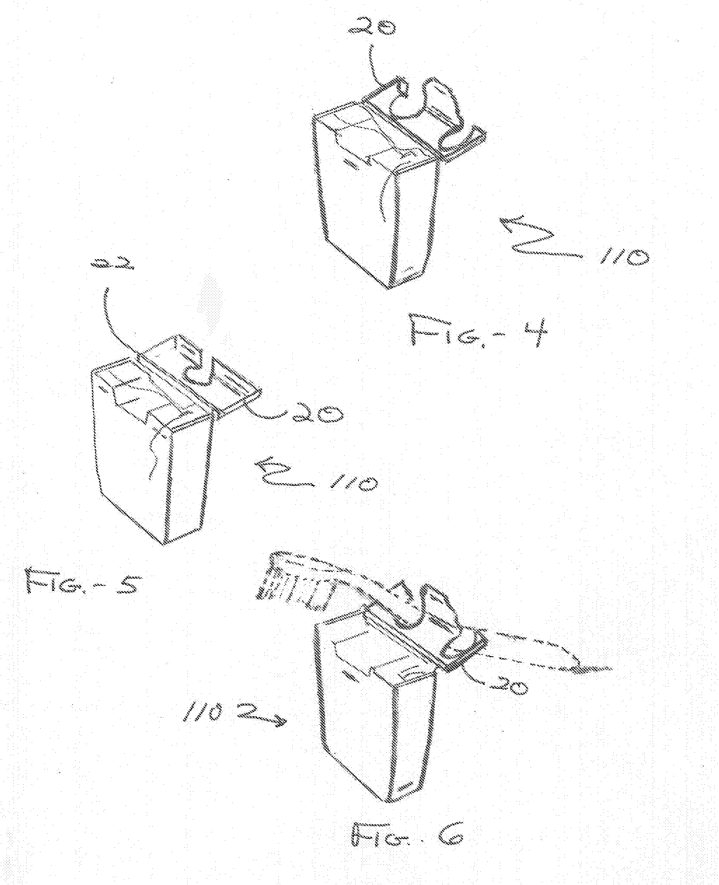

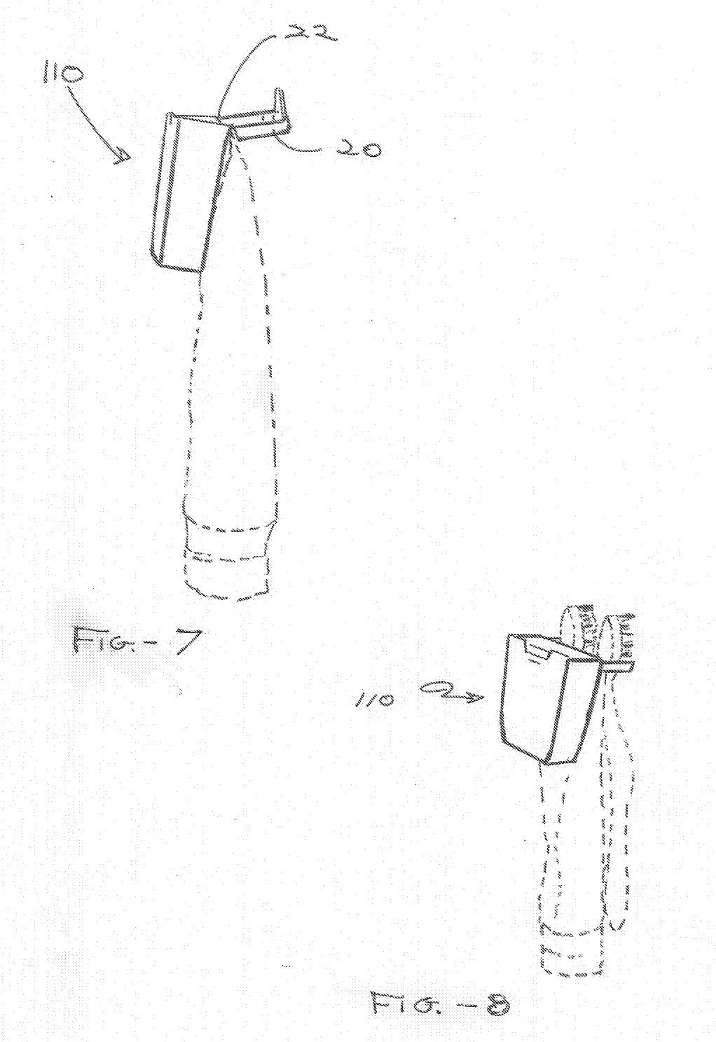

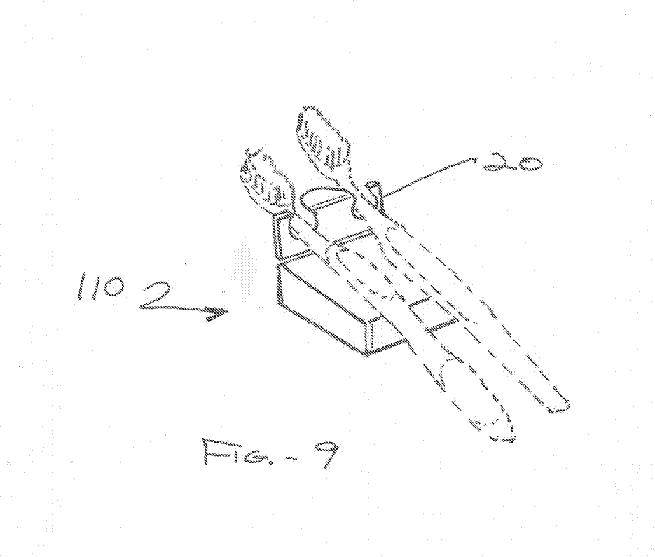

Referring to FIGS. 1-9, there are illustrated embodiments of a holder, generally designated by the numeral 10. The particular illustrated holder 10 is for retaining at least one toothbrush above a potentially contaminated surface, such as a bathroom countertop.

In the first embodiment, as can be seen in FIGS. 1-3, holder 10 is comprised of a body 12 having first and second ends and first and second opposing surfaces. A first flange 14 extends from (or proximate) the first end of the body 12 at an angle of less than 180° (relative to the first surface of the body 12) and a second flange 16 extends from (or proximate) the second end of the body 12 at an angle of less than 180° (relative to the second surface of the body 12). That is, the two flanges, 14 and 16, extend in substantially opposite directions.

The first flange 14 includes at least one, preferably two, openings therein for retaining a toothbrush above a surface. A short initial section of the flange 14 may extend from the body 12 at an acute angle before the remainder of the flange extends substantially perpendicularly to the body 12. The acute angled section provides an engagement area 18 for positioning the holder 10 on a crimped end of a tube (e.g., toothpaste), as illustrated by the arrow of FIG. 1 a. A dental floss container can be placed on the second flange 16 as well, to act as counterweight to the toothbrush(es). A lip 17 may be provided at the end of second flange 16 to help retain the floss container. The end might alternately be curved for the same purpose.

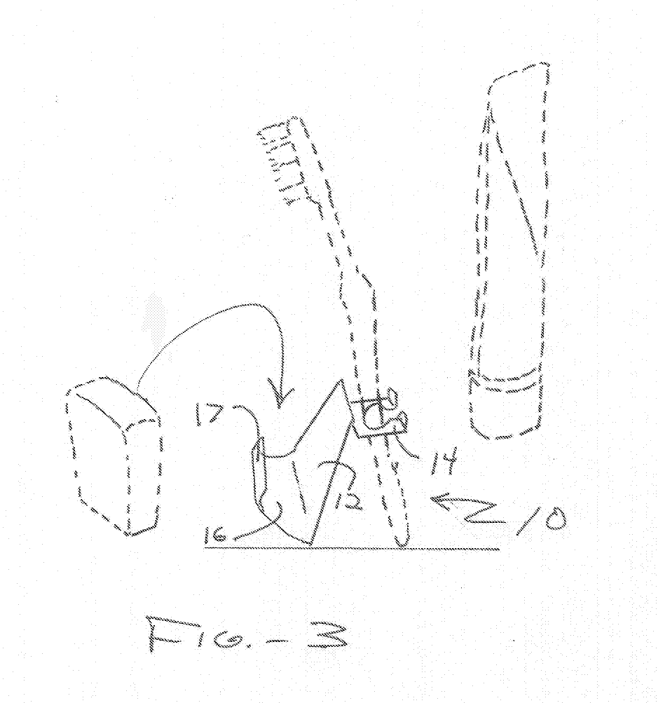

Alternately, as shown in FIGS. 2 and 3, the holder 10 may be positioned to hold at least one toothbrush in a substantially horizontal configuration or in a substantially vertical configuration without the use of a tube. The dental floss container may be positioned on the second flange 16 in the configuration of FIG. 3.

The body 10 and flanges, 14 and 16, are preferably of single construction, made from a metal or plastic. The specific angles of the extending flanges are not critical to the invention, so long as they allow support of a toothbrush and dental floss container.

Referring to FIGS. 4-9, an alternate embodiment of holder 110 is shown. This holder 110 is formed from the floss container itself, specifically the lid 20. As shown, the lid 20 includes at least one hole (or opening) formed therein to allow the retention of a toothbrush when the lid is in an open position. Much like the previous embodiment, the holder 110 can be positioned on the crimped end of a tube to suspend the toothbrush above a surface. The hinge 22 of the lid 20 engages the crimp much like the engagement area 18 of holder 10 (FIG. 1b). The toothbrush(es) and floss container provide perfect counterbalance to one another.

In an alternate configuration, the holder 110 may be used to retain toothbrushes in a horizontal position, as shown in FIG. 9. The holder 110 can be easily created by cutting or punching at least one hole in the hinged lid of an existing dental floss container. Of course, once all the dental floss has been used, the entire holder 110 can be discarded. This limits the potential for build-up of germs and molds due to retained moisture in the container.

The disclosed device 10 and 110 allows a standard toothbrush to be propped or retained in a position that allows it to air dry effectively. By providing the toothbrush storage into the floss container an individual will always have a toothbrush holder handy whether at home or while traveling. For example, for sanitary reasons, hotel bathrooms are not equipped to store toothbrushes. Hence this is the perfect solution for hotel users, students in housing, or anyone who spends time away overnight and would desire to maintain good oral hygiene by brushing and flossing as recommended.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A holder for a toothbrush comprising:
a body portion having first and second opposing ends and first and second opposing surfaces;
a first flange extending substantially at an angle of less than 180° relative to the first surface of the body portion and positioned proximate the first end of the body portion; and
a second flange extending substantially at an angle of less than 180° relative to the second surface of the body portion and positioned proximate the second end of the body portion;
wherein the first flange comprises at least one opening configured to retain a toothbrush therein.

2. The holder of claim 1, further comprising an engagement section positioned between the first surface of the body portion and the first flange.

3. The holder of claim 2, wherein the engagement section comprises an initial section of the first flange extending at an acute angle relative to the first surface of the body portion.

4. The holder of claim 2, wherein the engagement section is configured to engage a crimped end of a tube.

5. The holder of claim 1, wherein the first flange comprises at least two openings, each configured to retain a toothbrush therein.

6. The holder of claim 1, wherein the second flange extends substantially perpendicular to the second surface of the body portion.

7. The holder of claim 1, wherein the body, first flange and second flange are comprised of metal.

8. The holder of claim 1, wherein the body, first flange and second flange are comprised of a plastic.

9. The holder of claim 6, wherein the second flange is configured to retain a dental floss container thereon.

10. A combination toothbrush and floss container holder comprising:
a body portion having first and second opposing ends and first and second opposing surfaces;
a first flange extending substantially at an angle of less than 180° relative to the first surface of the body portion and positioned proximate the first end of the body portion;
a second flange extending substantially at an angle of less than 180° relative to the second surface of the body portion and positioned proximate the second end of the body portion; and
an engagement section positioned between the first surface of the body portion and the first flange configured to engage a crimped end of a tube;
wherein the first flange comprises at least one opening configured to retain a toothbrush therein and the second flange is configured to support a floss container.

11. The combination holder of claim 10, wherein the first flange comprises at least two openings, each configured to retain a toothbrush therein.

12. The combination holder of claim 10, wherein the second flange substantially extends at a 90° angle relative to the second surface of the body portion.

13. The combination holder of claim 10, wherein the body, first flange and second flange are comprised of metal.

14. The combination holder of claim 10, wherein the body, first flange and second flange are comprised of a plastic.

15. The combination holder of claim 10, wherein the second flange is configured to retain a dental floss container thereon.

16. A dental floss container comprising:
a body having four sidewalls and a bottom defining an open space;
a spool of dental floss positioned within the open space to dispense from an open top; and
a lid connected to one of the sidewalls via a hinge and capable of manual movement between an open and closed position;
wherein the lid includes at least one opening defined therein, the opening being configured to retain a toothbrush therein when the lid is placed in the open position.

17. The dental floss container of claim 16, wherein the lid includes at least two openings defined therein.

18. A method for a toothbrush holder comprising the steps of:
obtaining a dental floss container having four sides, a bottom and a lid having a hinge connecting the lid to one of the four sides; and
making at least one hole within the hinged lid sufficient to accommodate a toothbrush handle therein; and
inserting a toothbrush into the at least one hole.

19. The method of claim 18, further comprising the step of placing the container on a crimped end of a tube along the hinge of the lid such that the inserted toothbrush is on one side of the tube and the container is on an opposite side of the tube.
